(19) United States
(12) Patent Application Publication
(10) Pub. No.: US 2020/0237069 A1
(43) Pub. Date: Jul. 30, 2020

(54) APPARATUS AND METHOD FOR A LED FIXED HEAD BAND CONFIGURED FOR OUTWARD DISPLAY OF CONTENT TO ENGAGE/DISCTRACT AN INFANT

(71) Applicant: Judy Chien, New York, NY (US)

(72) Inventor: Judy Chien, New York, NY (US)

(21) Appl. No.: 16/846,652

(22) Filed: Apr. 13, 2020

Related U.S. Application Data
(63) Continuation-in-part of application No. 15/827,537, filed on Nov. 30, 2017.

(51) Int. Cl. A45D 8/36; G02B 27/01; G02B 7/00; F21V 33/00

(52) U.S. Cl. CPC A45D 8/36; G02B 27/0172; A45D 2008/004; F21V 33/0008; G02B 7/002

(57) ABSTRACT

In general, one aspect of the invention relates to a head-band that comprises a circumferential-shaped band configured to stretch and fit over a head of any size. The band rests and conforms generally to a forehead of a first user (mounted user) and a LED source is secured in a see-through sleeve on the head-band for an outward display of content to a second user wherein, the LED source is securely rested over the forehead of the first user and is positioned at a center of the first users forehead for a hands-free engagement from the first user with the second user to distract or engage a child.

### BACKGROUND

### Field of the Invention

The present invention generally relates to a head band configured with an LED source attached for outward of content. More particularly, the invention relates to an apparatus that provides an LED source to allow for the display screen side to be exposed to a second user to allow the wearer of the head band to engage or disctract the second user hands-free.

### Related Art

Light-emitting diodes (LEDs) are solid-state devices that convert electric energy directly into light of a single color. Because they employ “cold” light generation technology, in which most of the energy is delivered in the visible spectrum, LEDs don't waste energy in the form of non-light producing heat. In comparison, most of the energy in an incandescent lamp is in the infrared (or non-visible) portion of the spectrum. As a result, both fluorescent and HID lamps produce a great deal of heat. In addition to producing cold light, LEDs: 1. Can be powered from a portable battery pack or even a solar array, 2. Can be integrated into a control system, 3. Are small in size and resistant to vibration and shock, 4. Have a very fast “on-time” (60 nsec vs 10 msec for an incandescent lamp), 5. Have good color resolution and present low, or no, shock hazard.

The importance of being cap and visor free, other than the fact that it will avoid obstruction or interference with the engaged user, is the fact that there are no risks of engaged user from removing the cap from the mounted user. For instance, in situations where the mounted user is a parent attempting to distract the engaged user—in this case, a baby in need of a diaper change—the parent may display a distracting video and not fear the baby playing with the visor and dislodging the cap, or device.

U.S. patent—Head Apparatus with light emitting diodes (U.S. Pat. No. 6,719,437B2)—granted to Banning Lary and Todd Pendleton Lary claims and describes a baseball-type hat or headband, to which is attached one or more arrays of light emitting diodes to provide with efficient lighting. Additionally, commercially produced head-bands with LED are solely used for the purpose of entertainment, sports arenas, night walks, concerts etc.

By some estimates, a parent can plan to change over 3,000 diapers during baby's first year. That is a lot of diapers, and as the baby transforms from a tiny little newborn lump into a squirming, kicking, wiggly baby, diaper changing can get a lot more difficult. Having a wiggly, dirty-diapered baby can turn even the most mild-mannered moms into an Olympic-caliber wrestler. Most of your attempts at diaper changing start by first having to pin the baby, perhaps one might be interested in some other ways to safely change a squirmy baby's diaper.

There is a need for such a head mount, lacking any one of a visor, clip, mount, fixed LED display, retention straps, or mounting plate, which poses risks of display obstruction or being interfered with by the engaged user. For instance, a baby during a diaper change needs to be engaged with distracting video playback, while allowing the parent to be hands-free for convenience. The parent shouldn't have to worry about the baby removing the cap by tugging at the visor, nor should the baby have to look over a visor or stare at a reinforcing strap running through the middle of a display.

Thus, there is a need for a portable, compact and customizable head band with an LED source permanently fixed on the head-band, so that the LED source is securely rested over the center of the forehead to either distract or engage a baby.

### SUMMARY

The embodiments of the present invention relate to a circumferential-shaped head band configured to stretch and fit over a head of any size on a forehead of a user and a LED source permanently fixed on the head-band for an outward display of content to a second user wherein, the LED source is securely rested over the forehead of the first user and is positioned at a center of the first users forehead for a hands-free engagement from the first user with the second user to distract or engage a child.

In general, one aspect of the invention relates to a head-band that comprises a circumferential-shaped band configured to stretch and fit over a head of any size. The band rests and conforms generally to a forehead of a first user (mounted user) and a LED source is secured in a see-through sleeve on the head-band for an outward display of content to a second user wherein, the LED source is securely rested over the forehead of the first user and is positioned at a center of the first users forehead for a hands-free engagement from the first user with the second user to distract or engage a child.

In the same aspect, the LED source is securely rested over the forehead of the first user (mounted user) and the outward display is positioned at a center of the first users (mounted users) forehead. As such, the totality of the screen is orientated toward a second user (engaged user) during engagement with the second user (engaged user). The lack of cap and visor allows for increased exposure of the outward display and closer proximity to the engaged user. More importantly, there is no risk of the engaged user from tugging at the visor and dislodging the cap or the LED source. The lack of a mounting plate or reinforcing straps running over the head of the mounted user provides for additional comfort and freedom.

The device has multiple uses in the fields of travel, patient care, child care, etc. The device may be applicable for any scenario which calls for engaging and distracting an engaged user by another user (mounted user). The mounted user may engage and distract the engaged user with a plurality of colors, modes of music etc. By securely fixing the mobile device on one's head, the mounted user is hands-free to undergo various daily tasks, such as changing a diaper, feeding a baby, administering treatment to an elderly, etc. Additionally, the see-through sleeve may house a mobile device, phone, tablet or electronic reader for an outward display of any video or audio content which may be played on these devices.

As another object of the invention, a circumferential-shaped band is configured to stretch and fit over a head of any size and a LED source secured in a see-through sleeve wherein, the sleeve is securely affixed to a front surface of the head-band for an outward display of content to a second user. Additionally, a plurality of opposable inserts on the front surface of the head-band are configured to stretch and confirm to form a secure fit of the see-through sleeve so that the LED source is securely rested over the forehead of the first user and is positioned at a center of the first users forehead for a hands-free engagement from the first user with the second user to distract or engage a child.

As in the opposable inserts' embodiment, the fixed embodiment may prominently feature the outward display by having it securely rested over the forehead of the first user. The outward display is positioned at a center of the first users (mounted users) forehead and orientated toward a second user (engaged user) during engagement with the second user (engaged user).

In yet another object of the invention, a method of manufacturing is provided.

Other devices, apparatus, and/or products according to embodiments will be or will become apparent to one of ordinary skill in the art upon review of the following drawing and further description. It is intended that all such additional devices, apparatus, and/or products be included within this description, be within the scope of the present invention, and be protected by the accompanying claims.

### BRIEF DESCRIPTION OF THE DRAWINGS

FIG. 1a shows a front perspective view diagram according to aspects of the invention.

FIG. 2 shows a front perspective view housing a LED source according to aspects of the invention.

FIG. 3a shows a front perspective view housing a LED source fit over a user according to aspects of the invention.

FIG. 3b shows a side perspective view housing a LED source fit over a user during engagement according to aspects of the invention.

FIG. 4 shows a side perspective of an LED source engaging an infant according to an aspect of the invention.

FIG. 5 shows a perspective of the head-band according to an aspect of the invention.

### DETAILED DESCRIPTION

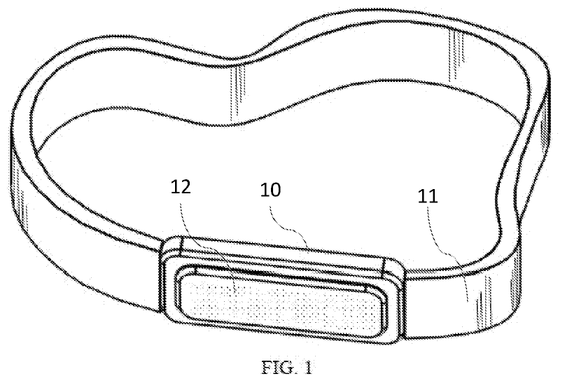

The following is a discussion and description of preferred specific embodiments of the LED fixed head-band as claimed, such being made with reference to drawings, and in particular to FIGS. 1 to 4 thereof, whereupon the same reference numerals are used to indicate the same or similar parts and/or structure. Such discussion and description is to illustrate and not to unduly limit the scope of the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

Referring to the drawings in detail and particularly to FIG. 1, the LED fixed head-band device is shown in a perspective and elevation views. FIG. 1 shows one of many embodiments that have been conceived by the inventor. Now in reference to FIG. 1, in its normal usage as a LED 10 fixed head band 11, the user may manipulate the position of the LED source 10 in the center of the head 11. The advantage of this is that the engaged user (not shown) will be exposed to a full display of the LED 10 source to distract a second user (not shown) without, the lack of an elaborate assembly (mounting plate and reinforcement straps). The apparatus in a preferred embodiment, as shown in FIGS. 1, may comprise of a circumferential-shaped band 11 configured to stretch and fit over a head of any size, the head-band resting and conforming generally to a forehead of a first user and a LED 10 source permanently fixed on the head-band 11 for an outward display of content 12 to a second user wherein, the LED 10 source is securely rested over the forehead of the first user and is positioned at a center of the first users forehead for a hands-free engagement from the first user with the second user to distract or engage a child.

Further yet, the LED 10 fixed head band 11 is of a unitary construction, including a terry cloth, elastic strap, pliable foam and, or sheath encased. In a preferred embodiment, the head band 11 portion is terry cloth with sufficient elasticity to fit over a head of any size, along with supporting the weight of any mobile device. The head-band 11 may be any one of, or combination of, durable materials, such as, polyester, nylon, latex, latex-free, and, or cotton. Additionally, in an embodiment the LED 10 fixed head-band 11 may be braided, knitted, or woven. They may each have a stretch value of at least 125%.

In an alternate embodiment of invention, the LED 10 fixed head-band 11 maybe in a sleeve casing. Additionally, the sleeve casing may have a LED source attached. The sleeve casing may be compatible with most majority bands of smartphone, such as iPhone 7/7 Plus, Samsung Galaxy S8 S7 S6, Note 5/4/3, HTC ONE, LG, Sony Xperia, Google Nexus Pixel and other phones with a screen size below or larger 6.3 inches. Ideally, the mobile device may have a screen size of 6.3 inches. Additionally, with minor manipulation of the head-band or sleeve casing, the mounted user may easily angle the LED 10 source or LED 10 fixed sleeve casing towards the engaged user, providing for a perfect frontal line of sight of the display 12.

Further yet in preferred embodiment of the invention, a top elevation view of the LED 10 fixed head band 11 in accordance with an aspect of the invention is shown. In an aspect of the invention, invention relates to a LED 10 fixed head-band 11 that comprises a circumferential-shaped band configured to stretch and fit over a head of any size. The band rests and conforms generally to a forehead of a first user (mounted user).

In the same aspect, the LED 10 source is securely rested over the forehead of the first user (mounted user) and the LED source 12 is positioned at a center of the first users (mounted users) forehead. As such, the totality of the LED 10 source is unobstructed and orientated toward a second user (engaged user) during engagement with the second user (engaged user). The lack of cap and visor allows for increased exposure of the LED 10 source and closer proximity to the engaged user. More importantly, there is no risk of the engaged user from tugging at the visor and dislodging the LED source. The lack of a mounting plate or reinforcing straps running over the head of the mounted user provides for additional comfort and freedom. Additionally, the mounted user may easily manipulate the head band 11 to further angle the LED 10 source for a more optimal line of sight, depending on the position and proximity of the engaged user. For instance, during a diaper change, a parent may want to tilt the head band 11 upwards, since the head of the parent is already positioned downwards. Conversely, the parent may want to not tilt the head band 11, especially when the parent and child may be eye-level with one another, such as during a feeding.

While not shown in FIG. 1, a head band 11 may further be reinforced in order to support the weight of larger and heavier devices. In such an embodiment, a rubber or foam band encased in a comfortable sheathing may be provided. The sheathing may be any one of, or combination of, cloth, textile, fabric, and, or any other flexible material, for example, nylon and or spandex sheathing. The encased foam material may be any one of a pliable and, or elastomeric material, conforming to the shape of the mounted user. The inner foam may be a made of any one of, or combination of heat-settable thermoplastic material and, or polymer with high tensile, medium pliable, and “memory”.

In yet another alternate embodiment of the invention, the LED 10 source is secured in a see-through sleeve on the head-band 11 wherein, the sleeve is affixed to a front surface of the front surface of the head-band 11 for an outward display 12 of content to the second user.

Additionally, in yet another preferred embodiment of the invention, the LED 10 source is at least one of, a plurality of colors, synced with music, self-adhesive, cuttable or linkable. The LED 10 source may be cut at different areas depending on the users' preferences and linked to a plurality of LED 10 sources to create a customized LED source.

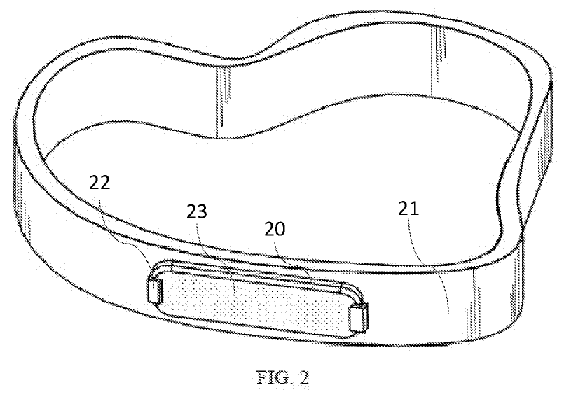

FIG. 2 illustrates a front perspective view an LED 20 source secured on the head-band 21 via a plurality of opposable inserts 22, according to aspects of the invention.

In a preferred embodiment of the invention, a head-band 21 comprises of a circumferential-shaped band configured to stretch and fit over a head of any size, where the band rests and conforms generally to a forehead of a first user. Further yet, in an embodiment of the present invention, a LED 20 source affixed via a plurality of opposable inserts 22 on a front surface of the head-band 21 configured to stretch and confirm to form a secure fit of the LED 20 source for an outward display 23 of content to a second user, wherein the LED 20 source is securely rested over the forehead of the first user and is positioned at a center of the first users forehead for a hands-free engagement from the first user with the second user to distract or engage a child.

In another embodiment wherein the band 21 does or does not comprise straps—affixed or not affixed—and the LED 20 source/mobile device, instead, secures on the band 21 by way of opposable inserts 22 cut through on the forehead portion of the front surface of the head-band 21. The user would simply insert each end of the LED 20 source/mobile device into each insert 22 disposed on the forehead portion of the front surface of the head-band 21. In some embodiments, the head-band 21 may comprise both the opposable straps (not shown) and the opposable inserts 22, giving the user the option of strapping the LED 20 source/device secure or inserting the LED 20 source/device secure. The straps (not shown) may be the entire length of the width of the band, or may be smaller, since the head-band 21 or inserts 22 may expand to conform to the size and shape of the LED 20 source/device. The inserts 22 may be spaced apart a standard LED 20 source/mobile device-length apart or the same distance the affixed opposable straps are apart from one another.

In an embodiment of the invention, the opposable inserts 22 maybe fabricated from the same material as the head-band 21 and may be formed seamlessly and coextensively with the head-band 21. Further yet, the opposable inserts 22 may mimic various appendages and, or other features of at least one an any one of an animal. Additionally, the opposable inserts 22 may be any one of an animated character, feature of an animated character, and, or printed graphics related to an animated character and, or a feature of an animated character. Further yet, in an embodiment of the invention, a retractable cord may be attached on the head-band 21 to distract the user. Additionally, the retractable cord may be made of the same material as the head-band 21. Further yet, in an embodiment, the retractable cord may further comprise a toy, stuffed animal or the like to further distract/engage a second user.

While not shown in FIG. 2, the head-band 21 may comprise an element projecting from an outer surface of the head-band 21, and may be configured for dangling over the second user during engagement with the second user. The element may be fabricated from the same material as the head-band 21, formed seamlessly and coextensively with the head-band 21. Conversely, the element may be a different material as the head-band 21, affixed during or after manufacturing of the head-band 21. Additionally, the element may be a molded and, or free-stranded mock hair projecting from a top edge of the head-band 21. In a preferred embodiment, the head-band 21 device may feature a novelty design element, which may be a protrusion mimicking the dorsal appendages of fish and other animals, i.e. shark fins, etc. The protrusion in this particular embodiment may be disposed on a top, front, or sides of the head band portion. Other embodiments cover any and all other novelty design features, which may be distracting to children, including, but not limited to, animated characters, copyrighted characters requiring licensing arrangements, i.e., Disney-themed characters, etc. These elements may also be disposed on a top, front, or sides of the head band portion.

In yet another alternative embodiment, also not shown, an elasticized or drawstring band may be circumferentially housed within the head band portion. The terminal ends may be exposed through eyelets disposed on the front or side of the head band portion. Pulling and tying each end together may allow for tighter and more secure fit of the head band portion over the head of a mounted user. The drawstring may additionally be drawn or undrawn using a draw cord closure mechanism. All of the above-mentioned mechanisms allow the embodiment to securely fit over a mounted users head of any size, and support the weight of any mobile device or LED 20 source.

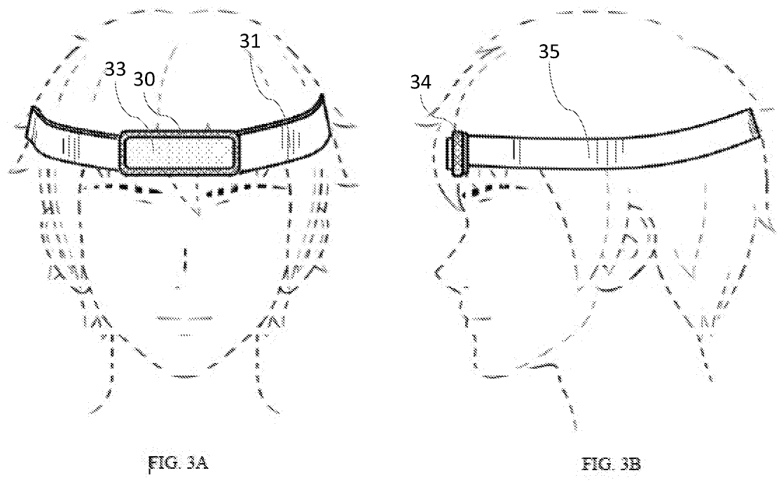

FIG. 3a and FIG. 3b illustrate two different vantage points of the head-band 31, 35 housing a LED 30,34 source fit over a user's head. FIG. 3a illustrates a close-up front perspective of housing a LED 30 source fit over a user's head. On the other hand, FIG. 3b illustrates a side perspective of housing a LED 34 source fit over a user head during engagement. As seen in FIGS. 3a and 3b, the LED 30, 34 source is securely rested over the forehead of the first user (mounted user) and the LED 30, 34 source is positioned at a center of the first users (mounted users) forehead. As such, the totality of the screen is unobstructed, and orientated toward a second user (engaged user, not shown) engagement with the second user (engaged user). The lack of cap and visor allows for increased exposure of the display 33 and closer proximity to the engaged user. More importantly, there is no risk of the engaged user from tugging at the visor and dislodging the cap/mobile device/LED 30, 34 source. The lack of a mounting plate or reinforcing straps running over the head of the mounted user provides for additional comfort and freedom.

The apparatus, as shown in FIG. 3a and FIG. 3b, may comprise of a head-band 31, 35 portion of a unitary construction, including a terry cloth, elastic strap, pliable foam and, or sheath encased. In a preferred embodiment, the head-band 31,35 portion is terry cloth with sufficient elasticity to fit over a head of any size, along with supporting the weight of the LED 30, 34 source. Furthermore, the head-band 31,35 may be any one of, or combination of, durable materials, such as, polyester, nylon, latex, latex-free, and, or cotton. The individual straps additionally may be braided, knitted, or woven.

While not shown in FIG. 3a or 3b, in one potential embodiment, the circumferential-shaped band may be configured to stretch and fit over a head of any size, and rest/conform generally to a forehead of a first user. Furthermore, the band may comprise opposable elastic straps, wherein the back surface of the straps may be affixed to a front surface of the band via an adhesive fabric fastener. The fastener-coupled opposable elastic straps may be configured to stretch and conform tightly over any point of any mobile device/LED source with display. As a result, the mobile device/LED source display may be securely rested over the forehead of the first user and positioned over the forehead at a choosing of the first user and orientated toward a second user during engagement with the second user.

Also not shown in FIG. 3a or 3b wherein the band does or does not comprise straps—affixed or not affixed—and the LED source/mobile device, instead, secures on the band by way of opposable inserts cut through on the forehead portion of the front surface of the head band. The user would simply insert each end of the LED source/mobile device into each insert disposed on the forehead portion of the front surface of the head band. In some embodiments, the head band may comprise both the opposable straps and the opposable inserts, giving the user the option of strapping the LED source/device secure or inserting the LED source/device secure. The straps may be the entire length of the width of the band, or may be smaller, since the band or inserts may expand to conform to the size and shape of the LED source/device. The inserts may be spaced apart a standard LED source/mobile device-length apart or the same distance the affixed opposable straps are apart from one another.

Also not shown in FIG. 3a or 3b is an embodiment wherein the band does or does not comprise straps—affixed or not affixed—and the LED source/mobile device, instead, secures on the band by way of a see-through sleeve configured to house a LED source/mobile device, said sleeve affixed to a front surface of said band, wherein at least a single side of said sleeve is entirely open to slip in said device. The user would simply insert the LED source/mobile device into the at least single side of the sleeve that is open. In some embodiments, the head-band may comprise both the opposable straps and, or the opposable inserts, and, or the sleeve, giving the user the option of strapping the LED source/device secure, inserting the LED source/device secure, or slipping the LED source/device secure. The straps may be the entire length of the width of the band, or may be smaller, since the band or inserts may expand to conform to the size and shape of the LED source/device. The see-through sleeve may be the size of a standard LED source/mobile device or larger than the standard LED source/mobile device.

In yet another alternate embodiment of the invention, at least a single side of the see-through sleeve is entirely open for easy slipping of the LED source. Further yet, the see-through sleeve is fabricated from the same material as the band, formed seamlessly and coextensively with the band. Furthermore, the see-through sleeve is a different material as the band, affixed during or after manufacturing of the band. Additionally, the see-through sleeve may house any one of a mobile device, phone, tablet or electronic reader.

In other embodiments, (not shown) the opposable elastic straps are attached onto the head-band, such that the straps are affixed to the head-band, rather than being slidably disposed over the circumference of the head band. In yet other embodiments, the straps may be disposed on a back surface with a fabric adhesive fastener portion to allow affixing onto the complementary fabric adhesive fastener portion running at least the length of the front-facing portion of the head band.

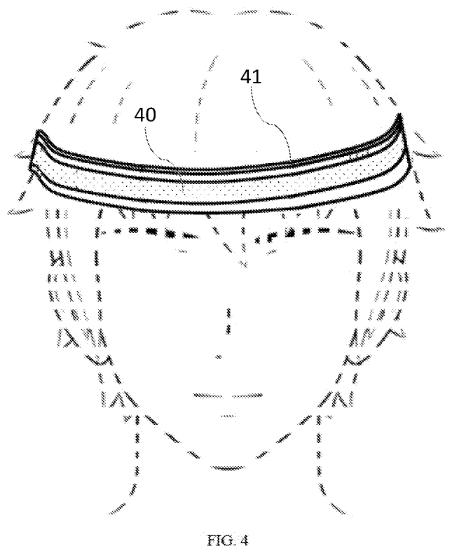

Now with reference to FIG. 4. FIG. 4 depicts in a preferred embodiment, a user wearing a circumferential-shaped head-band 41 configured to stretch and fit over a head of any size, said head-band 41 resting and conforming generally to a forehead of a first user with an LED 40 source permanently fixed on the head-band for an outward display of content to a second user wherein, the LED 40 source is securely rested over the forehead of the first user and is positioned around a circumference of the first users forehead for a hands-free engagement from the first user with the second user to distract or engage a child. Further yet, the circumferential-shaped head-band 41 is a sweat-absorbent head-band 41 generally used for absorbing sweat from a user's hair and, or forehead during physically strenuous activity.

In yet another alternate embodiment of the invention, the LED 40 source is secured in a see-through sleeve on the head-band 41 wherein, said sleeve is affixed to a front surface of the head-band 41 for an outward display of content to the second user. Additionally, the LED 40 source is at least one of, a plurality of colors, synced with music, self-adhesive, cuttable or linkable. The LED 40 source has at least one of static mode, fade mode, flash mode or music activated mode.

In other alternate embodiments, rather than the terry cloth head-band, a more rigid internal crux may be used to affix the straps onto. The crux may be composed of any one of, or a combination of, a soft, moldable, flexible, stretchable, temper or plastic alloy. Further yet, in another embodiment, the internal crux may be encased by a sheathing of any one or a combination of foam or foam beads made of either any one of, or a combination of, polystyrene or polyurethane. The foam or the foam beads can be homogeneously or heterogeneously distributed throughout the head band portion.

The foam or foam beads and the internal crux may be further stitched and encased in any one of a combination of cloth, terry cloth, textile material, casing, sheath, fabric, padding or any other flexible material, for example, nylon and or spandex sheathing. The stitching may be done using similar color thread as the color of the material used or contrasting colored threads depending on the preference of the customer. The preferred embodiment incorporating the encasing material used for the head-band device could be of varying colors, patterns and styles including, but not limited to, animated characters, sports teams, college teams, company logos, school and university logos etc.

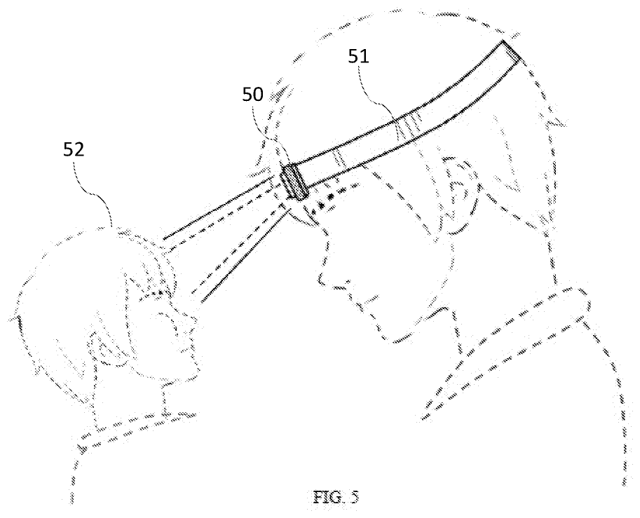

Now with reference to FIG. 5, an embodiment wherein a head-band comprises of a circumferential-shaped band 51 configured to stretch and fit over a head of any size, said band 51 resting and conforming generally to a forehead of a first user and a LED 50 source permanently fixed on the head-band 51 for an outward display of content to a second user 52 wherein, the LED 5 source is securely rested over the forehead of the first user and is positioned at a center of the first users forehead for a hands-free engagement from the first user with the second user 52 to distract or engage a child.

The head-band device as described in the current application can be manufactured using several different techniques. The device can be given a personalized touch by hand-making and stitching an individual piece, according to the client's desire and wish or can be mass produced in a industrial unit setting to cater to an economical buyer.

Therefore, the foregoing is considered as illustrative and descriptive of a number of embodiments covering the novel aspects of the head and neck device, and it is not intended to be limited to the details shown, since various modifications and structural changes may be made without departing in any way from the spirit of the present invention.

While this specification contains many specific execution details, these should not be interpreted as limitations on the scope of any inventions or of what may be claimed, but rather as descriptions of features specific to particular embodiments of particular inventions. Certain features that are described in this specification in the context of separate embodiments can also be implemented in combination in a single embodiment. Contrariwise, various features that are described in the context of a single embodiment can also be implemented and interpreted in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub combination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A head-band comprising of:
a circumferential-shaped band configured to stretch and fit over a head of any size, said band resting and conforming generally to a forehead of a first user; and
a LED source permanently fixed on the head-band for an outward display of content to a second user wherein, the LED source is securely rested over the forehead of the first user and is positioned at a center of the first users forehead for a hands-free engagement from the first user with the second user to distract or engage a child.

2. The head-band of claim 1,
wherein the circumferential-shaped band is a sweat-absorbent head-band generally used for absorbing sweat from a user's hair and, or forehead during physically strenuous activity.

3. The head-band of claim 1,
wherein the LED source is secured in a see-through sleeve on the head-band wherein, said sleeve is affixed to a front surface of the front surface of the head-band for an outward display of content to the second user.

4. The head-band of claim 1,
wherein the LED source is at least one of, a plurality of colors, synced with music, self-adhesive, cuttable or linkable.

5. The head-band of claim 1,
wherein the LED source has at least one of static mode, fade mode, flash mode or music activated mode.

6. The head-band of claim 1,
wherein at least a single side of said see-through sleeve is entirely open for easy slipping of the LED source.

7. The head-band of claim 1,
wherein the see-through sleeve is fabricated from the same material as the band, formed seamlessly and coextensively with the band.

8. The head-band of claim 1,
wherein the see-through sleeve is a different material as the band, affixed during or after manufacturing of the band.

9. The head-band of claim 1,
wherein the see-through sleeve may house any one of a mobile device, phone, tablet or electronic reader.

10. A head-band comprising of:
a circumferential-shaped band configured to stretch and fit over a head of any size, said band resting and conforming generally to a forehead of a first user;
a LED source affixed via a plurality of opposable inserts on a front surface of the head-band configured to stretch and confirm to form a secure fit of the LED source for an outward display of content to a second user; and
wherein the LED source is securely rested over the forehead of the first user and is positioned at a center of the first users forehead for a hands-free engagement from the first user with the second user to distract or engage a child.

11. The head-band of claim 10,
wherein the opposable inserts are fabricated from the same material as the band, formed seamlessly and coextensively with the band.

12. The head-band of claim 10,
wherein the opposable inserts are of a different material as of the band either affixed during or after manufacturing of the band.

13. The head-band of claim 10,
wherein the opposable inserts may mimic various appendages and, or other features of at least one an any one of an animal.

14. The head-band of claim 10,
wherein the opposable inserts may be any one of an animated character, feature of an animated character, and, or printed graphics related to an animated character and, or a feature of an animated character.

15. A head-band comprising of:
a circumferential-shaped band configured to stretch and fit over a head of any size, said band resting and conforming generally to a forehead of a first user;
a LED source secured in a see-through sleeve wherein, said sleeve is permanently affixed to a front surface of the head-band for an outward display of content to a second user; and
wherein the LED source is securely rested over the forehead of the first user and is positioned at a center of the first users forehead for a hands-free engagement from the first user with the second user to distract or engage a child.

16. The head-band of claim 15,
wherein the see-through sleeve may house any one of a mobile device, phone, tablet or electronic reader.

17. The head-band of claim 15,
further comprising an element projecting from an outer surface of the band configured for dangling over the second user during engagement with the second user.

18. The head-band of claim 15,
wherein the element mimics the appendages and, or other features of an any one of an animal.

19. The head-band of claim 15,
wherein the element may be any one of an animated character, feature of an animated character, and, or printed graphics related to an animated character and, or a feature of an animated character.

20. The head-band of claim 15,
wherein the element is fabricated from the same material as the band, formed seamlessly and coextensively with the band.
